(19) United States
(12) Patent Application Publication
(10) Pub. No.: US 2016/0343028 A1
(43) Pub. Date: Nov. 24, 2016

(54) SYSTEMS AND METHODS FOR PREDICTING RELATIONSHIP MILESTONES

(71) Applicant: MASTERCARD INTERNATIONAL INCORPORATED, NEW YORK, NY (US)

(72) Inventors: KENNY UNSER, FAIRFIELD, CT (US); JEAN-PIERRE GERARD, Croton-On-Hudson, NY (US)

(73) Assignee: MASTERCARD INTERNATIONAL INCORPORATED, NEW YORK, NY (US)

(21) Appl. No.: 14/715,366

(22) Filed: May 18, 2015

(51) Int. Cl. G06Q 30/02; G06Q 50/00

(52) U.S. Cl. CPC G06Q 30/0255; G06Q 30/0269; G06Q 50/01

(57) ABSTRACT

Systems and methods are provided for predicting consumer relationship status and/or milestones. Payment transaction data can be leveraged to predict such consumer relationship statuses or milestones, whereby payment transaction data gleaned from a payment network can be aggregated in accordance with certain characteristics present in the payment transaction data, the aggregations being indicative of a particular relationship status or milestone. A weighting factor may then be applied to each of the various aggregations to determine a likelihood that a particular aggregation is actually indicative of some predicted relationship status or milestone. Based on the combination of the factoring results, a relationship status or milestone can be predicted and output as a deliverable to, e.g., a marketing firm, business entity, etc. Additionally, data from third-party or external information sources can be accessed/obtained and included in the relationship status or milestone prediction process.

### TECHNICAL FIELD

The present disclosure is generally related to electronic transactions. More particularly, the present disclosure is directed to systems and methods for predicting relationship status or milestones based upon electronic transaction data.

### BACKGROUND

The use of payment cards for a broad spectrum of cashless transactions has become ubiquitous in the current economy, accounting for hundreds of billions of dollars in transactions during a single year. Moreover marketers, business establishments, and the like often engage in targeted marketing or advertising efforts in order to present consumers with the option to purchase products and/or services relevant to their respective needs and desires.

### SUMMARY

In accordance with one embodiment, a non-transitory computer-readable medium has computer executable program code embodied thereon. The computer executable program code is configured to cause a computer system to review payment transaction data and summarize activities identified within the payment transaction data in one or more aggregations that are potentially indicative of a relationship status or milestone. The computer executable program code is configured to further cause the computer system to apply a weighting factor to each of the one or more aggregations to determine a probability that the relationship status or milestone is accurate. Additionally still, the computer executable program code is configured to cause the computer system to generate a relationship status or milestone prediction based upon a combination of the determined probabilities.

In accordance with another embodiment, a system comprises first and second databases as well as predictive engine. The first database stores aggregations potentially indicative of a relationship status or milestone determined based upon payment transaction data. The second database stores a plurality of weighting factors for determining a probability that the relationship status or milestone is accurate are stored. The predictive engine is adapted to generate a relationship status or milestone prediction based upon a combination of the determined probabilities.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 illustrates an example payment card transaction processing system.

FIG. 2 illustrates an example relationship status or milestone prediction system in accordance with various embodiments.

FIG. 3 is a flow chart illustrating various operations that may be performed to store relationship data in accordance with various embodiments.

FIG. 4 is a flow chart illustrating various operations that may be performed for modeling transaction data in accordance with various embodiments.

FIG. 5 is a flow chart illustrating various operations that may be performed to predict a relationship status or milestone in accordance with various embodiments.

FIG. 6 illustrates an example computing module that may be used in implementing features of various embodiments.

The drawings are described in greater detail in the description and examples below.

### DETAILED DESCRIPTION

The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

As alluded to previously, entities such as marketers, advertisers, business establishments, etc. may rely on directed advertising and marketing techniques in order to target those consumers that may have an interest in purchasing products and services relevant to their needs and desires. For example, social media websites may allow a user to indicate his/her relationship status, such as whether the user is single, engaged, etc. Advertisers that advertise on such social media websites may then target advertising to the user based on this relationship status information. When a user's relationship status is “single,” an advertiser may send advertisements for dating services to the user. When a user's relationship status is “engaged,” an advertiser may send the user advertisements for jewelers that sell engagement rings.

However, advertising and marketing efforts based solely on consumer self-reporting, third party information, demographic information, and/or publicly available information, such as the public records of marriage certificates, salary information, etc. may still be ineffective. For example, a user's relationship status may be outdated and incorrect if the user fails to update his/her relationship status regularly. Additionally, third parties that post or publicize certain data may only provide such data sporadically or with little frequency. Hence, such information reporting may lag behind a consumer's current status, again resulting in ineffectual advertising.

Accordingly, various embodiments of the technology disclosed herein are directed to systems and methods of predicting consumer relationship status and/or milestones. In particular, real-time or near real-time payment transaction data can be leveraged to predict relationship status or milestones. For example, “raw” payment transaction data gleaned from a payment network can be aggregated in accordance with certain characteristics present in the raw payment transaction data. That is, the raw payment transaction data can be summarized and/or grouped into various “aggregations” that can be indicative of a particular relationship status or milestone. A weighting factor may then be applied to each of the various aggregations to determine a likelihood that a particular aggregation is actually indicative of some predicted relationship status or milestone. Based on the combination of the factoring results, a relationship status or milestone can be predicted and output as a deliverable to, e.g., a marketing firm, business entity, etc. Additionally, data from third-party or external information sources can be accessed/obtained and included in the relationship status or milestone prediction process. Thus, based on a consumer's spending behavior, the timeliness of relationship information can be improved and/or enhanced and future relationship milestones or changes to a relationship status can be predicted in advance.

It should be noted that although various embodiments are described in the context of predicting personal relationship status or milestones, the technology disclosed herein can be applied to predicting professional relationships status or milestones, life events such as the birth of a child, or any other relevant status or milestone. Moreover, the technology disclosed herein may have utility not only to advertisers, business entities, etc., but can also be utilized by other types of entities having a need or desire to predict the status of or milestones related to person, group of person, or other entity(ies).

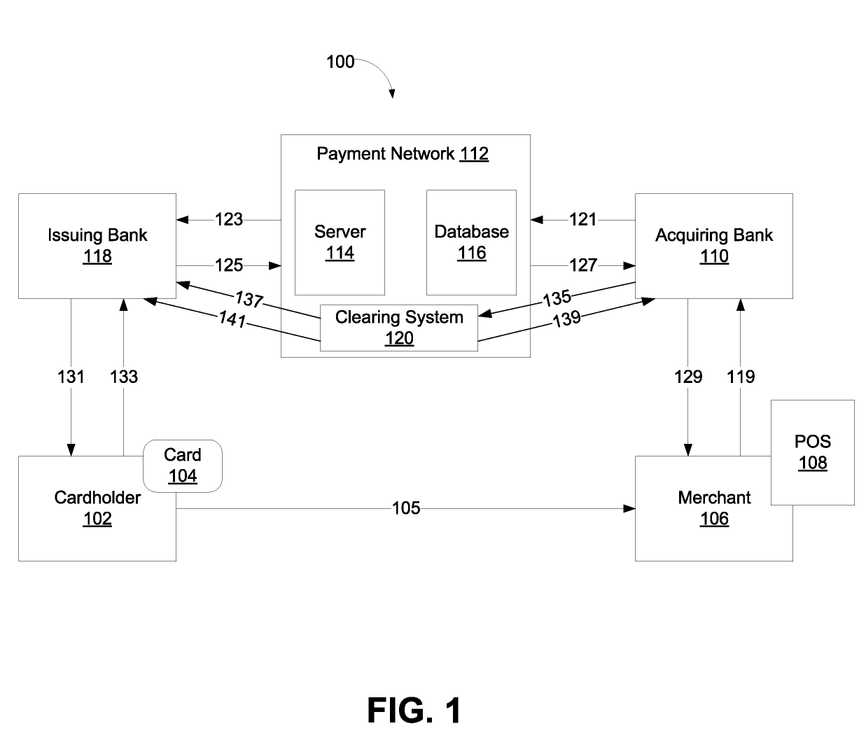

FIG. 1 depicts an example payment card transaction processing system 100. In a typical card-based payment system transaction, a cardholder 102 presents a credit/debit/prepaid card 104 to a merchant 106 for the purchase of goods and/or services. This transaction is indicated by arrow 105. A “card” 104, as used herein, can refer to a conventional magnetic-stripe credit, debit card, or similar proximity payment device (utilized on its own or incorporated into another device such as a mobile telephone, personal digital assistant (PDA), etc.) having near field communications (NFC) capabilities, such as a radio frequency identification (RFID) chip implemented therein. A “card” 104 can further refer to virtual or limited use account numbers and electronic wallets.

It is understood that prior to the occurrence of such a transaction, cardholder 102 was issued card 104 by an issuing bank 118. Moreover, it will be understood that merchant 106 has established a relationship with an acquiring bank 110 (also referred to as a merchant bank), thereby allowing merchant 106 to receive cards as payment for goods and/or services. That is, acquiring banks and issuing banks, such as acquiring bank 110 and issuing bank 118, may participate in various payment networks, including payment network 112. One such payment network is operated by MasterCard International Incorporated, the assignee of the present disclosure.

After presentation of card 104 to merchant 106 by cardholder 102, merchant 106 may send an authorization request (indicated by arrow 119) to acquiring bank 110 via a point-of sale (POS) terminal 108 located at or otherwise controlled by merchant 106. In turn, acquiring bank 110 communicates with payment network 112 (indicated by arrow 121), and payment network 112 communicates with issuing bank 118 (indicated by arrow 123) to determine whether cardholder 102 is authorized to make transaction 105. The issuing bank 118 either approves or declines the authorization request and thereafter transmits the response back to merchant 106 (indicated by arrows 125, 127 and 129). Merchant 106 may then either complete or cancel transaction 105 based upon the response to the authorization request.

If transaction 105 is approved, in accordance with processes called clearing and settlement, the transaction amount will be sent from issuing bank 118 through payment network 112 to acquiring bank 110. The transaction amount, minus certain fees, will thereafter be deposited within a bank account belonging to merchant 106. Issuing bank 118 thereafter bills cardholder 102 (indicated by arrow 131) for all transactions conducted over a given period of time by sending a cardholder statement to cardholder 102. Cardholder 102 follows by submission of payment(s) (as indicated by arrow 133) to issuing bank 118. This submission of payment(s) (as indicated by arrow 133) by cardholder 102 may be automated (e.g., in the case of debit transactions), may be initiated by cardholder 102 for the exact amount matching amounts of purchases during the statement period (e.g., charge cards or credit balances paid in full), and/or may be submitted (in part or in whole) over a period of time that thereby reflects the amount of the purchases, plus any financing charges agreed upon beforehand between cardholder 102 and issuing bank 118 (e.g., revolving credit balances).

Payment network 112 preferably includes at least one server 114 and at least one database 116. Server 114 may include various computing devices such as a mainframe, personal computer (PC), laptop, workstation or the like. Server 114 can include a processing device and can be configured to implement an authorization and clearance process, which can be stored in computer storage associated with server 114. Database 116 may include computer readable medium storage technologies such as a floppy drive, hard drive, tape drive, flash drive, optical drive, read-only memory (ROM), random access memory (RAM), and/or the like. Server 114 and database 116 may be controlled by software/hardware and may store data to allow it to operate in accordance with aspects of the present disclosure.

POS terminal 108 is in data communication, directly or indirectly, and at least from time to time, with, e.g., an acquirer host computer (not shown) that is part of payment network 112 and is operated for or on behalf of acquiring bank 110, which handles payment card transactions for merchant 106. Server 114 may be operated by or on behalf of the payment network 112, and may provide central switching and message routing functions among the member financial institutions of the payment card network. Issuing bank 118 also preferably makes use of an issuer host computer (not shown), and an access point (not shown) via which the issuer host computer exchanges data messages with server 114. It should be noted that in practice, payment card transaction processing system 100 may involve a large number of cardholders, POS terminals, acquirer host computers, issuer host computers, and access points. In general, the acquirer host computer can receive authorization requests from POS terminals, forward the authorization requests through payment network 112, receive authorization responses, and relay the authorization responses to POS terminal 108. Moreover, the issuer host computer may in general, receive authorization requests from server 114 and transmit authorization responses back to server 114 with respect to the authorization requests.

Clearing (which can happen after transmission of the authorization response if approved) can refer to a process by which issuing bank 118 exchanges transaction information with acquiring bank 110. Acquiring bank 110 can transmit transaction information to a clearing system 120 (indicated by arrow 135). Clearing system 120 can validate the transaction information, and forward it to issuing bank 118 (indicated by arrow 137), which prepares data to be included on a payment statement for cardholder 102. Clearing system 120 may then provide reconciliation to both issuing bank 118 and acquiring bank 110 (indicated by arrows 139 and 141).

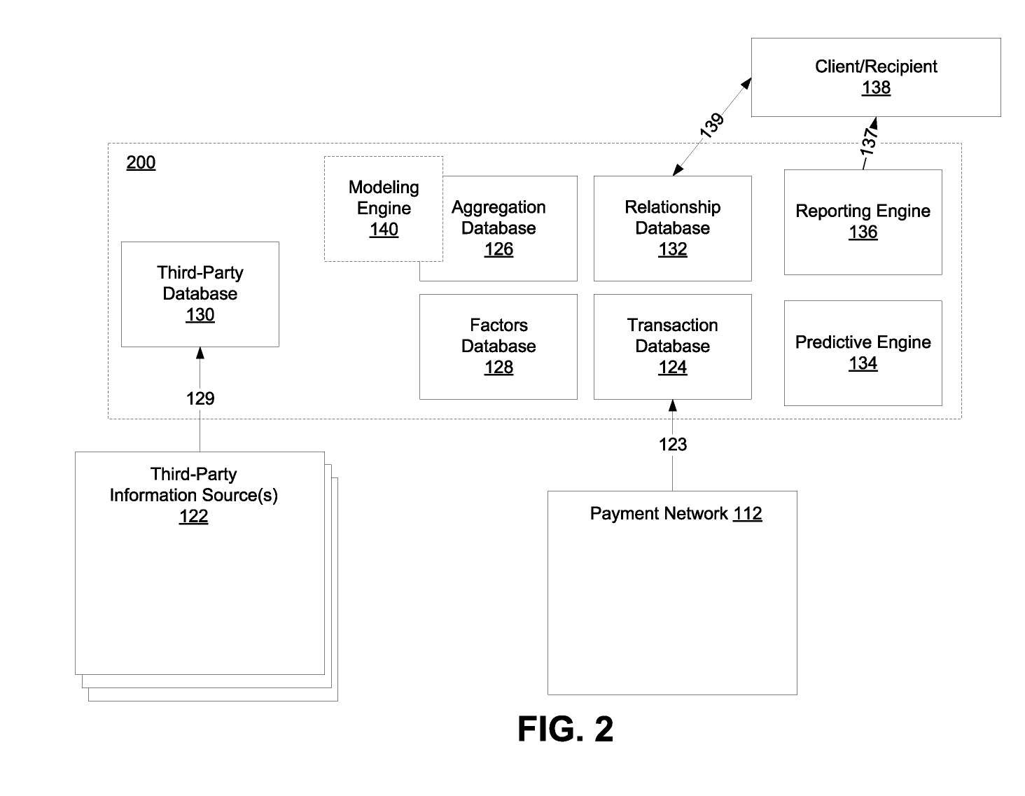

FIG. 2 depicts an example predictive system 200 for predicting relationship status or milestones in accordance with various embodiments. As described previously, the technology disclosed herein contemplates utilizing transaction data to predict relationship status or milestones for a consumer/cardholder. Accordingly, predictive system 200 communicates with payment network 112 (of FIG. 1) to obtain transaction data processed by payment network 112 (indicated by arrow 123) for storage within a transaction database 124. It should be noted that transaction database 124 can be updated periodically, e.g., as relevant transactions occur, hourly, daily, weekly, etc., or aperiodcally, as may be desired. In accordance with one embodiment, transaction data can be obtained from or upon processing by clearing system 120 in order to provide information that is sufficiently “real-time” in order accurately predict relationship statuses or milestones. The transaction data that may be obtained from payment network 112 and subsequently stored in transaction database 124 may be, e.g., entire transaction records, or some relevant portion or subset thereof, such as merchant ID, purchase date, and purchase amount information.

Upon receiving and storing transaction data in transaction database 124 from payment network 112, the aforementioned aggregation of transaction data can be performed, where the aggregations are subsequently stored in an aggregation database 126. Weighting factors from a factors database 128 can be applied to the aggregated transaction data in aggregation database 126 to determine a likelihood that a particular aggregation is indicative of some predicted relationship status or milestone. Based on the combination of the resulting factoring, a relationship status or milestone can be predicted and stored in a relationship database 132. The aforementioned aggregation, application of weighting factors, and resulting prediction can be performed by predictive engine 134. Alternatively, some or each of the databases can have implemented therein or may be associated with their own specific processors or engines. This relationship status data may then be output as a deliverable to, e.g., a marketing firm, business entity, etc. via a reporting engine/database 136, to client/recipient 138 (indicated by arrow 137). Alternatively, client/recipient 138 may access the relationship database 132 directly via an application programming interface (API) call (indicated by arrow 139).

Additionally, data from third-party information source(s) 122 can be accessed/obtained and included in the relationship status or milestone prediction process. For example, third-party information source(s) 122 may include one or more of a social media or networking website, application, or data store, from which known relationship status or milestone information can be gleaned and stored in third-party database 130. Such third-party data can be used to augment the relationship status data stored within relationship database 132 or vice versa. For example, third-party relationship data may be updated by relationship data determined by predictive system 200, made more accurate by relationship data determined by predictive system 200, etc.

It should be noted that each of databases 124, 126, 128, 130, and 132 may be any type of database suitable for the storage of data as disclosed herein. Each database may store data in a single database, or may store data across multiple databases and accessed through a network. Network configurations as disclosed herein may include a local area network (LAN), a wide area network (WAN), a wireless network (e.g., WiFi), a mobile communication network, a satellite network, the Internet, fiber optic, coaxial cable, infrared, radio frequency (RF) or any other suitable configuration as would be apparent to persons having skill in the relevant art.

Moreover, data may be stored on any type of suitable computer readable media, such as optical storage (e.g., a compact disc, digital versatile disc, blu-ray disc, etc.) or magnetic storage (e.g., a hard disk drive). A database may be configured in any type of suitable database configuration, such as a relational database, a structured query language (SQL) database, a distributed database, an object database, etc. Suitable configurations and database storage types will be apparent to persons having skill in the relevant art.

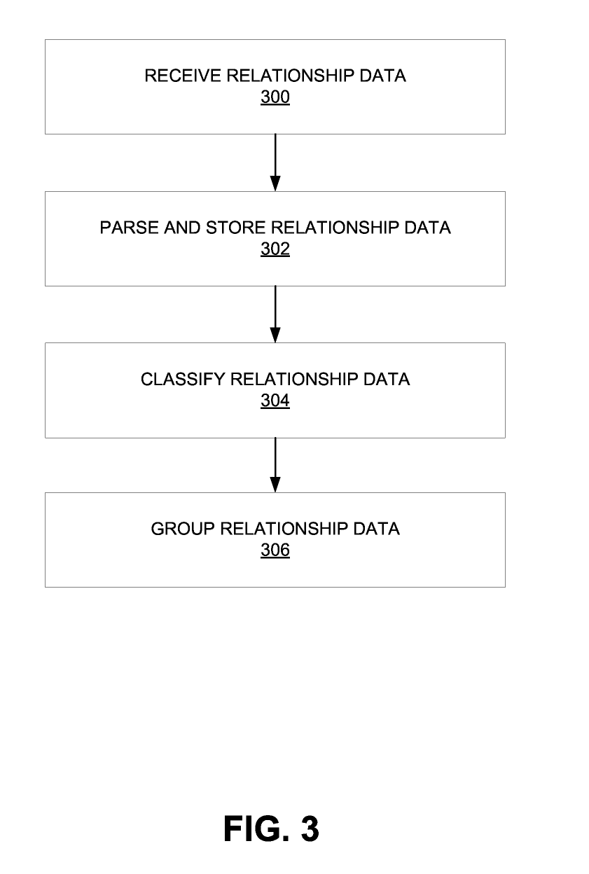

An operational flow chart is depicted in FIG. 3 describing example processes for relationship data status processing and storage. At operation 300, relationship data may be received. Relationship data may be determined internally by predictive system 200, received from a third-party information source(s) 122, and/or combined with or augmented by relationship data from a third-party information source(s) 122. However, when received from third-party information source(s) 122, the relationship data may be collected based on an individual level or an aggregate level. Moreover, based on a desired security level and/or a type of information source that third-party information source(s) 122 may be, personal identifying information may be included or excluded. That is, the relationship data can be anonymized in accordance with certain embodiments to protect the identities of individuals or entities.

Third-party information source(s) 122 may be, as described above, a social media website, an online dating service, an online wedding registry, a news website, such as one that publishes engagement announcements, survey or polling websites, etc. Identifying elements associated with relationship data that may be retrieved, accessed, or obtained from third-party information source(s) 122 can include, but is not limited to the following: individual identification indicia; credit card numbers; names; addresses; demographic profiles; social media identifiers; and the like. Such identifying elements may be used to link relationship data to transaction data, e.g., on an individual level, a demographic level, etc.

Relationship data may be any data indicative of and/or associated with a relationship or relationship status. For example, relationship data can include a status, such as dating, exclusive relationship, engaged, married, etc. Relationship data may also encompass information such as a calendar date(s) associated with and/or having some significance to a relationship. Further still, relationship data make include information associated with another party or parties in a relationship, such as relationship partner information. Relationship data itself can be categorized in a variety of ways including, but not limited to the following categories: new relationship, e.g., newly dating, newly married, recently cohabitating, existing relationship, e.g., long-term engagement, long-term marriage, etc. As alluded to previously, key dates, such as those indicative of anniversaries, birthdays, etc. may also be considered to be relationship data that can obtained from third-party information source(s) 122. Further still, partner information, such as information identifying a spouse, a significant other, etc. can also be obtained, e.g., the spouse's demographic profile, age, gender, income, etc. Accordingly, at operation 302, the relationship data may then be parsed in order to extract the relevant information from the relationship data to be classified (discussed below) and stored in relationship database 132. It should be noted that the manner(s) in which the relationship data is parsed can vary depending, e.g., on the source of the relationship data. For example, if the relationship data is gathered from the Internet, Web scraping techniques (using, e.g., web bots or web crawlers) may be used to automatically record and transform unstructured data on web pages, typically in HTML format, into structured data that can be automatically stored and analyzed in a data repository, for example, third-party database 130. Other options for parsing relationship data may include, but are not limited to obtaining a direct feed from one or more third-party information sources 122, manual gathering and parsing of public data, etc.

At operation 304, the (parsed) relationship data is classified. For example, coded values may be assigned to the relationship data. That is, and depending on what the relationship data is interpreted to represent, the relationship data may be associated with a code indicating a particular relationship status, e.g., single father, new relationship, newly engaged, etc. At operation 306, the relationship data can be grouped, e.g., into logical groupings. That is, statistical methods or rules can be applied to the relationship data to arrive at groups of relationship data indicative of the same/similar relationship status or milestone. Such statistical methods may include, but are not limited to: clustering; decision tree analysis; Chi-squared Automatic Interaction Detection (CHAID), a specific type of decision tree analysis; and regression analysis. Thus, groupings such as “new relationships” may encompass relationship data indicative of new dating relationships, new marriages, and the like. Other logical groupings may be indicative of other relationship statuses/milestones, e.g., serial monogamists, family planning, newly cohabitating, and recently engaged. As will be described in greater detail below, relationship data can be combined and/or analyzed against transaction data to determine or predict subsequent relationship statuses or milestones.

As described above, transaction data can be aggregated and stored in a manner(s) suggestive of relationship statuses or milestones. In order to properly characterize transaction data as being indicative of a certain relationship status or milestone, various embodiments of the technology disclosed herein further provide a modeling process for identifying a transaction “profile” indicative of a relationship status or milestone. The modeling process may further create a mechanism by which relationship statuses or milestones are associated with the observance of such transaction profiles (i.e., associated with subsequent transactions). It should be noted that the models disclosed herein may be stand-alone models or may be utilized to augment previously known relationship statuses.

For example, deviation from a consumer's “normal” spending pattern may be indicative of a relationship milestone or change in relationship status, e.g., purchasing dinner at a higher class establishment and/or spending, e.g., twice as much, may indicate that the consumer has gone on a date. As another example, a large ticket jewelry purchase may suggest a future engagement. Thus, if an individual is known to have a social media status indicating “in a relationship” it may be predicted that in thirty days, for example, the individual's social media status will be updated to “engaged.” It should be noted that the different models developed in accordance with various embodiments may have varying degrees of certainty with respect to a predicted relationship status or milestone. For example, if an individual stops paying his/her utility bill, subsequently rents a moving vehicle, etc., it may be implied that the individual has moved in with a significant other. However, the individual may have also simply moved in with a roommate that is not a significant other. On the other hand, a prediction that an individual is getting married in the near future based upon the purchase of wedding planning services is highly likely to be an accurate prediction.

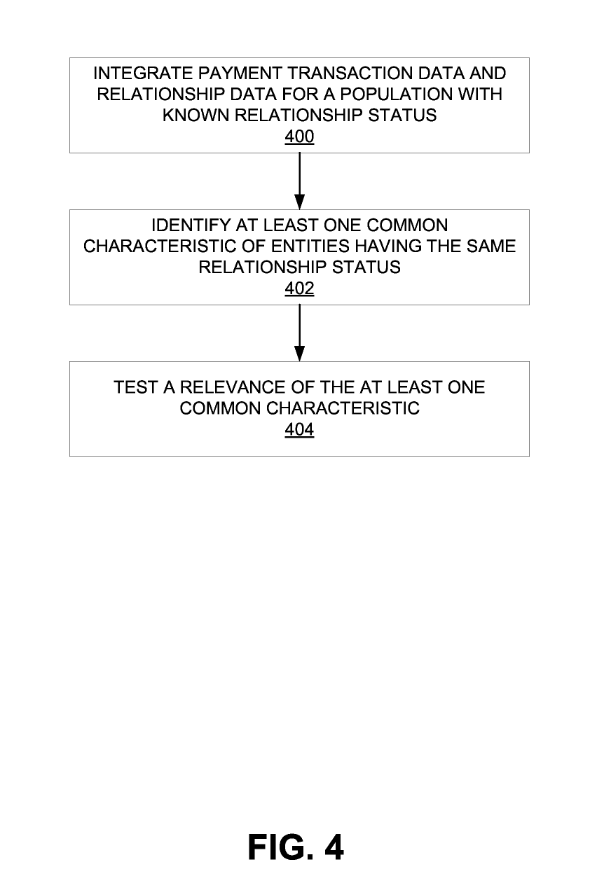

FIG. 4 is an operational flow chart illustrating example processes that can be performed to model transaction profiles indicative of relationship statuses or milestones. At operation 400, payment transaction data (e.g., historical payment transaction data) and relationship data are integrated for some predetermined population having a known relationship status. In this way, various payment transaction profiles, or types/instances of payment transactions can be associated with or characterized as being indicative of a particular relationship status or milestone. At operation 402, at least one common characteristic of entities having the same relationship status is identified. Various statistical methods or algorithms may be applied to link such common characteristics, e.g., indexing, regression analysis, correlation, and clustering.

At operation 404, a relevance of the at least one common characteristic is tested. That is, each of the common characteristics of those individuals having the same relationship status are tested to ascertain if these characteristics can be relied upon to distinguish or differentiate these individuals from others. In this way, the accuracy of a relationship status prediction can be determined. For example, a set of individuals having a known relationship status may be withheld from the common characteristics identification of operation 402. After identifying such common characteristics, this withheld set of individuals can be used to test how well the common characteristics predict relationship status. As with common characteristics identification, various statistical methods and/or algorithms may be utilized to test these common characteristics, including, e.g., indexing, correlation testing, regression analysis, etc. Consider an example when known married individuals are observed as to purchase movie tickets approximately six times a year on average. Although married individuals are observed to purchase movie tickets approximately six times a year, these acts of purchasing do not necessarily mean that the purchaser is married. In contrast, consider that consumers who remit payment to an online dating service are known to be currently single, whereas such payments are infrequently or never observed with respect to married individuals. Therefore, testing the common characteristic of paying for an online dating service amongst those who are single can be performed to determine if it really is indicative of being single by making a comparison with other individuals, in this case, married individuals.

Ultimately, a repeatable process can be created that allows determinative common characteristics to be used in conjunction with payment transaction data to predict relationship statuses or milestones. That is, raw payment transaction data can be received and subsequently summarized and/or grouped into various aggregations that can be indicative of a particular relationship status or milestone, and predicted relationship status can be output, i.e., a relationship status, a relevant date or date range, e.g., forecasted, historical and/or present status, and a confidence score or rating associated with the predicted relationship status.

It should be noted that the modeling process described above can be performed by predictive engine 134 or by a separate modeling engine 140. It should further be noted that it is the result(s) of the modeling process described herein that allows for the aggregation of the raw (current or new) payment transaction data as will be described below.

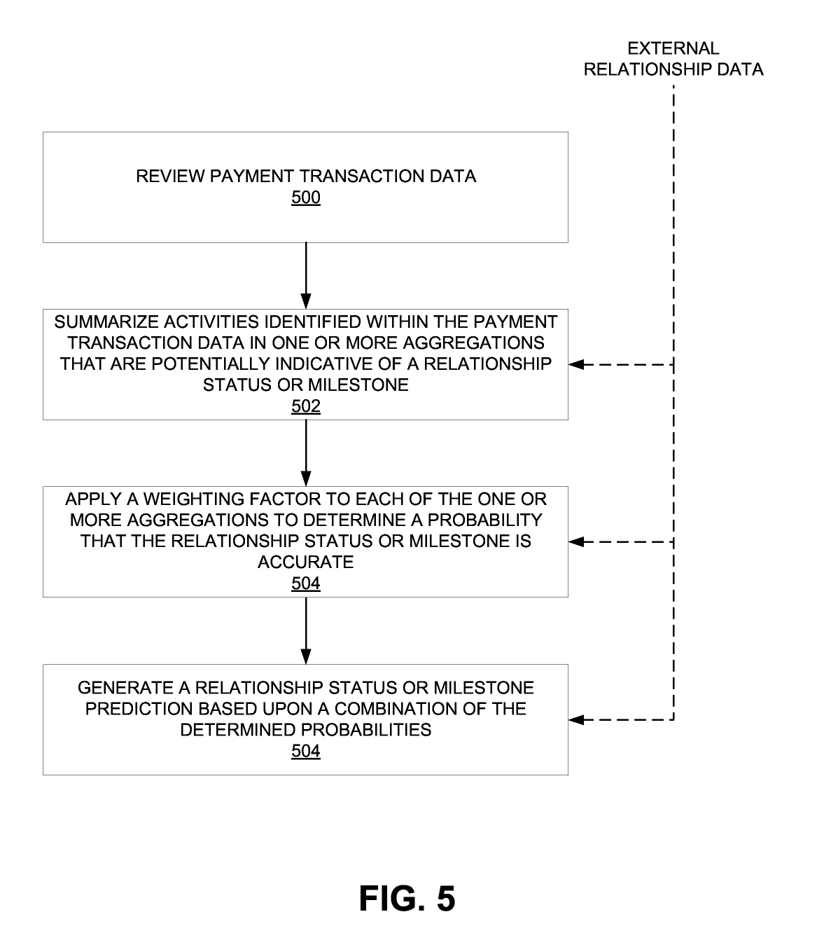

FIG. 5 is an operational flow chart illustrating example processes that may be performed to interpret transaction data and predict relationship statuses and milestones in accordance with various embodiments. At operation 500, payment transaction data may be reviewed to determine their relevance to a relationship status or milestone. As previously discussed, such payment transaction data can be transaction records received via a payment network. For example, it may be determined that a consumer has made monthly payments to an online dating service beginning in January and continuing through March. Also between these months, it may be determined from the payment transaction data that the consumer has made purchases at upscale dining establishments several times on Fridays and Saturdays, while the frequency of fast food purchases for the consumer has declined. Further still, the payment transaction data may reveal a purchase for two airline tickets to an island destination in April that coincides with a reservation for a single hotel room at the island destination. Moreover, the payment transaction data may reflect dining and entertainment purchases during April that suggest the purchases were made for two people, e.g., $40 for movie theater tickets and $100 dinner purchase. Reviewing such payment transaction data may entail, in some embodiments, scoring the payment transaction data as it is received from a payment network. It should be noted that, e.g., the same or similar algorithms as those described previously, such as indexing, regression analysis, correlation, and clustering can be utilized for this reviewing process as well. It should be further noted that variables may be created from raw payment data to capture a relevant purchase behavior(s).

At operation 502, activities identified within the payment transaction data are summarized into one or more aggregations that are potentially indicative of a relationship status or milestone. In accordance with one embodiment, the payment transaction data is reviewed from a temporal and purchase-amount perspective to determine whether any activity is suggestive of a relationship status or milestone. Following the above example, the payment transaction data can be summarized in the following aggregations: a) January purchases suggest a relationship status of “single” given the observed payment to the online dating service; b) March purchases still suggest a relationship status of “single” given the continued payment to the online dating service; c) Food purchases during the months of January through March suggest a relationship status of “dating” given the increasing restaurant ticket size; d) Food purchases during the months of January through March suggest a relationship status of “dating” given the decrease in frequency of fast food purchases; and e) Two-person travel purchases suggest a relationship status of “dating” or “in a committed relationship.”

At operation 504, a weighting factor can be applied to each of the one or more aggregations to determine a probability or likelihood that the relationship status or milestone is accurate. That is, factors can be numerical values or other type of rating indicia that can be assigned to a payment transaction aggregation or summary. For example, such factors can be stored in factors database 128 along with associated transaction activities such that when a commensurate transaction activity is observed, the appropriate factor can be assigned to that transaction activity. For example, actively paying for a dating service subscription can be a strong indicator of single status, while being a strong negative indicator of married status. Recent registration with a dating service can be assigned a factor that strongly suggests a cardholder has likely experienced a relationship breakup.

Upon assigning the factors to the transaction data aggregations, the resulting combination of factors can be analyzed to determine an overall likelihood that the cardholder is in a particular relationship stage or has experienced a particular relationship milestone. In some examples, analysis of the combination of factors can be, e.g., comparing the numbers of types of indicators, e.g., the combination of factors results in 3 assignments of factors indicating a strong likelihood of dating status versus only 1 assignment of a factor indicating a median likelihood of married status. In such a case, the prediction would be that the cardholder has relationship status of dating. In other embodiments, one or more calculations such averaging numerical factor values to arrive at an average numerical probability can be performed. Again, following the above example, it may be that the resulting combination of factors suggests a 90 percent chance that the cardholder is dating, a 10 percent chance that the cardholder is married, a 12 percent chance that the cardholder is divorced, and 80 percent chance that the cardholder is in a committed relationship, and a 20 percent chance that the cardholder is actively dating outside a committed relationship.

At operation 506, a relationship status or milestone prediction is generated based upon a combination of the determined probabilities. That is, based upon the combination of factors, the cardholder may be determined to be in a committed relationship, but not married. This predicted relationship data may then be stored in relationship database 128 for reporting to client/recipient 138 via reporting engine 136 or via an API through which client/recipient 138 can directly access the predicted relationship data. When reporting such predicted relationship data, various types of deliverables or outputs can be generated such as, e.g., marketing reports, model inputs, list appends, social studies, etc.

It should be noted that external relationship data from an external or third-party information source(s), such as third-party information source(s) 122, can be obtained and utilized in predicting relationship statuses or milestones as well instead of relying solely on predicted relationship data determined as described above. Utilizing external relationship data can be useful for more quickly arriving at a predicted relationship status, as a “baseline” relationship status may be established. Additionally, external relationship data can be used as a verification tool to enhance the probability that a determined relationship status or milestone is accurate. For example, a social media website can share a user's self-reported relationship status, e.g., as being “in a relationship.” Upon reviewing payment transaction data for that user (once the user is linked to, e.g., a credit card, used in making payments), it may be determined that the user recently made a large jewelry purchase in an amount commensurate with two months of that user's monthly income. It should be noted that social media or other information repositories can often include self-reported income ranges. Using the same or similar aggregation and factor assignment techniques as those described previously, it can be determined that the purchase (transaction activity) is consistent with the purchase of an engagement ring. It can then be determined that the user is likely to be engaged. In turn, it can be reported out to the social media website that the user is likely to change his/her social media website relationship status to “engaged” within the next 30 days.

In this way, the social media website can optimize ad placement for an online dating service. Traditionally, the social media website would rely solely on a user's self-reported relationship status to display ads to only those users that report themselves as single. There can be many users, however, who report no relationship status and other users who are in new relationships and have not yet updated their relationship status on the social media website. By augmenting the self-reported relationship status with predicted relationship status or milestone data, the social media website can provide a greater percentage of interaction with the online dating service's advertisements.

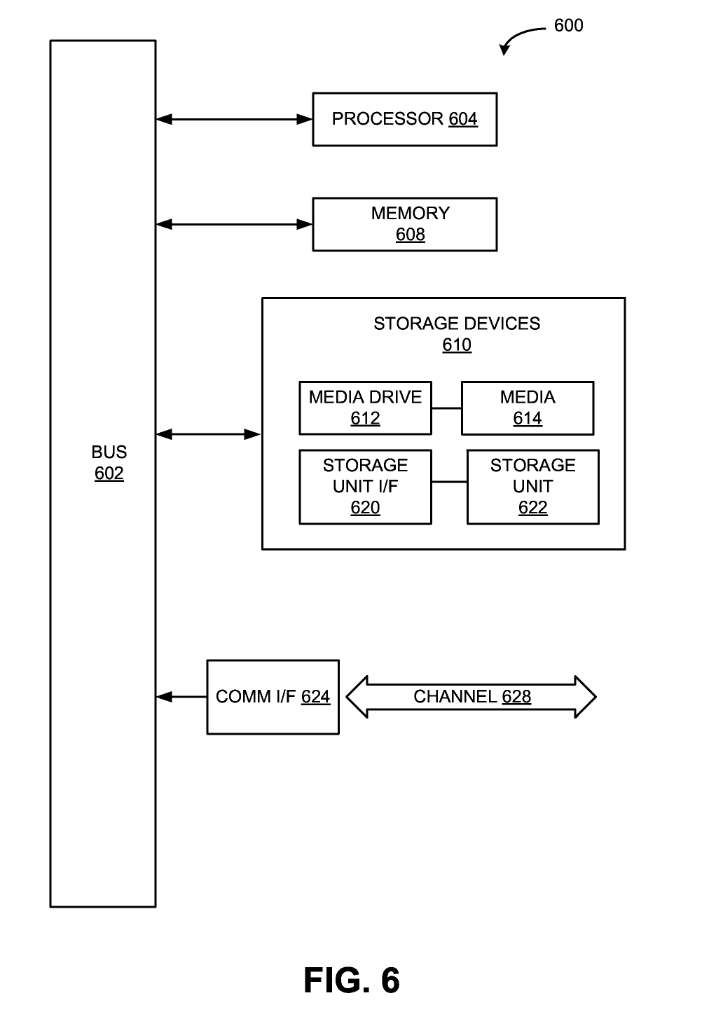

FIG. 6 illustrates an example computing module 600, an example of which may be a processor/controller resident on a device, such as a network device, or a processor/controller used to perform certain processing functions (e.g., predictive engine 134 of FIG. 2), that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 6. Various embodiments are described in terms of this example-computing module 600. After reading this description, it will become apparent to a person skilled in the relevant art how to implement the application using other computing modules or architectures.

Referring now to FIG. 6, computing module 600 may represent, for example, computing or processing capabilities found within mainframes, supercomputers, workstations or servers, or any other type of special-purpose or general-purpose computing devices as may be desirable or appropriate for a given application or environment.

Computing module 600 might include, for example, one or more processors, controllers, control modules, or other processing devices, such as a processor 604. Processor 604 might be implemented using a general-purpose or special-purpose processing engine such as, for example, a microprocessor, controller, or other control logic. In the illustrated example, processor 604 is connected to a bus 602, although any communication medium can be used to facilitate interaction with other components of computing module 600 or to communicate externally.

Computing module 600 might also include one or more memory modules, simply referred to herein as main memory 608. For example, preferably random access memory (RAM) or other dynamic memory might be used for storing information and instructions to be executed by processor 604. Main memory 608 might also be used for storing temporary variables or other intermediate information during execution of instructions to be executed by processor 604. Computing module 600 might likewise include a read only memory (“ROM”) or other static storage device coupled to bus 602 for storing static information and instructions for processor 604.

The computing module 600 might also include one or more various forms of information storage devices 610, which might include, for example, a media drive 612 and a storage unit interface 620. The media drive 612 might include a drive or other mechanism to support fixed or removable storage media 614. For example, a hard disk drive, a floppy disk drive, a magnetic tape drive, an optical disk drive, a CD or DVD drive (R or RW), or other removable or fixed media drive might be provided. Accordingly, storage media 614 might include, for example, a hard disk, a floppy disk, magnetic tape, cartridge, optical disk, a CD or DVD, or other fixed or removable medium that is read by, written to or accessed by media drive 612. As these examples illustrate, the storage media 614 can include a computer usable storage medium having stored therein computer software or data.

In alternative embodiments, information storage devices 610 might include other similar instrumentalities for allowing computer programs or other instructions or data to be loaded into computing module 600. Such instrumentalities might include, for example, a fixed or removable storage unit 622 and a storage unit interface 620. Examples of such storage units 622 and storage unit interfaces 620 can include a program cartridge and cartridge interface, a removable memory (for example, a flash memory or other removable memory module) and memory slot, a PCMCIA slot and card, and other fixed or removable storage units 622 and interfaces 620 that allow software and data to be transferred from the storage unit 622 to one or more components of computing module 600.

Computing module 600 might also include a communications interface 624. Communications interface 624 might be used to allow software and data to be transferred between computing module 600 and external devices. Examples of communications interface 624 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 624 might typically be carried on signals, which can be electronic, electromagnetic (which includes optical) or other signals capable of being exchanged by a given communications interface 624. These signals might be provided to communications interface 624 via a channel 628. This channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 608, storage unit interface 620, media 614, and channel 628. These and other various forms of computer program media or computer usable media may be involved in carrying one or more sequences of one or more instructions to a processing device for execution. Such instructions embodied on the medium are generally referred to as “computer program code” or a “computer program product” (which may be grouped in the form of computer programs or other groupings). When executed, such instructions might enable the computing module 600 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A non-transitory computer-readable medium having computer executable program code embodied thereon, the computer executable program code configured to cause a computer system to:
review payment transaction data;
summarize activities identified within the payment transaction data in one or more aggregations that are potentially indicative of a relationship status or milestone;
apply a weighting factor to each of the one or more aggregations to determine a probability that the relationship status or milestone is accurate; and
generate a relationship status or milestone prediction based upon a combination of the determined probabilities.

2. The non-transitory computer-readable medium of claim 1, wherein the computer executable program code configured to cause the computer system to review the payment transaction data further causes the computer system to determine a relevance of the payment transaction data to at least one of a known or predetermined relationship status or milestone.

3. The non-transitory computer-readable medium of claim 1, wherein the computer executable program code is configured to further cause the computer system to receive the payment transaction data periodically or aperiodically from a payment network.

4. The non-transitory computer-readable medium of claim 1, wherein the computer executable program code configured to cause the computer system to summarize the activities causes the computer system to summarize the activities based upon at least one of a temporal perspective and a purchase-amount perspective.

5. The non-transitory computer-readable medium of claim 1, wherein the computer executable program code is configured to further cause the computer system to receive externally-obtained relationship data.

6. The non-transitory computer-readable medium of claim 5, wherein the computer executable program code configured to cause the computer system to summarize the activities causes the computer system to summarize the activities utilizing the externally-obtained relationship data as a baseline indication of the relationship status or milestone.

7. The non-transitory computer-readable medium of claim 5, wherein the computer executable program code is configured to further cause the computer system to verify the accuracy of the relationship status or milestone based upon the externally-obtained relationship data.

8. The non-transitory computer-readable medium of claim 5, wherein the computer executable program code configured to cause the computer system to generate the relationship status or milestone prediction causes the computer system to generate the relationship status or milestone prediction utilizing the externally-obtained relationship data as at least one of a baseline indication of the relationship status or milestone.

9. The non-transitory computer-readable medium of claim 5, wherein the externally-obtained relationship data is received from at least one third-party information source.

10. The non-transitory computer-readable medium of claim 9, wherein the computer executable program code is configured to further cause the computer system to at least one of classify and group the externally-obtained relationship data based upon one or more characteristics of one or more elements of the relationship data.

11. The non-transitory computer-readable medium of claim 1, wherein the computer executable program code is configured to further cause the computer system to model historical payment transaction data to identify payment transaction profiles indicative of known relationship statuses or milestones.

12. The non-transitory computer-readable medium of claim 11, wherein the computer executable program code configured to further cause the computer system to model the historical payment transaction data causes the computer system to integrate the historical payment transaction data and relationship data for a population of entities with known relationship statuses.

13. The non-transitory computer-readable medium of claim 12, wherein the computer executable program code configured to further cause the computer system to model the historical payment transaction data causes the computer system to identify at least one common characteristic of the entities having at least one of the same or similar relationship status.

14. The non-transitory computer-readable medium of claim 13, wherein the computer executable program code configured to further cause the computer system to model the historical payment transaction data causes the computer system to test a relevance of the at least one common characteristic to verify accuracy of the payment transaction profiles.

15. A system, comprising:
a first database in which aggregations potentially indicative of a relationship status or milestone determined based upon payment transaction data are stored;
a second database in which a plurality of weighting factors for determining a probability that the relationship status or milestone is accurate are stored; and
a predictive engine adapted to:
apply at least one of the plurality of weighting factors to each of the one or more aggregations resulting in a combination of the determined probabilities; and
generate a relationship status or milestone prediction based upon the combination of the determined probabilities.

16. The system of claim 15, further comprising a payment network from which the payment transaction data is obtained.

17. The system of claim 15, further comprising at least one third-party information source from which externally-obtained relationship data is received.

18. The system of claim 15, further comprising a reporting engine adapted to access a third database in which the generated relationship status or milestone prediction is stored and transmit the generated relationship status or milestone prediction to a client.

19. The system of claim 15, further comprising a modeling engine adapted to model historical payment transaction data to identify payment transaction profiles indicative of known relationship statuses or milestones.

20. The system of claim 19, wherein the predictive engine applies the identified payment transaction profiles to the payment transaction data to generate the aggregations that are potentially indicative of the relationship status or milestone.
